(19) United States
(12) Patent Application Publication
(10) Pub. No.: US 2016/0071008 A1
(43) Pub. Date: Mar. 10, 2016

(54) Methods and Systems for Multi-Model Radial Basis Function Neural Network Based Non-Linear Interference Management in Multi-Technology Communication Devices

(71) Applicant: QUALCOMM Incorporated, San Diego, CA (US)

(72) Inventors: Sheng-Yuan Tu, San Diego, CA (US); Farrokh Abrishamkar, San Diego, CA (US); Insung Kang, San Diego, CA (US)

(21) Appl. No.: 14/849,542

(22) Filed: Sep. 9, 2015

Related U.S. Application Data
(60) Provisional application No. 62/048,519, filed on Sep. 10, 2014.
(60) Provisional application No. 62/106,751, filed on Jan. 23, 2015.
(60) Provisional application No. 62/106,755, filed on Jan. 23, 2015.
(60) Provisional application No. 62/106,756, filed on Jan. 23, 2015.
(60) Provisional application No. 62/106,764, filed on Jan. 23, 2015.

(51) Int. Cl. G06N 3/08

(52) U.S. Cl. CPC G06N 3/08

(57) ABSTRACT

The various embodiments include methods and apparatuses for canceling nonlinear interference during concurrent communication of multi-technology wireless communication devices. Nonlinear interference may be estimated using a multi-model radial basis function neural network with Hammerstein structure by executing a radial basis function on aggressor signals at a hidden layer of the radial basis function neural network with Hammerstein structure to obtain hidden layer outputs, augmenting aggressor signal(s) by weight factors, infusing the hidden layer outputs by infusion factors, and, executing a linear combination of the augmented output, at an intermediate layer to produce a combined hidden layer outputs. At an output layer, a linear filter function may be executed on the hidden layer outputs to produce an estimated nonlinear interference used to cancel the nonlinear interference of a victim signal.

### RELATED APPLICATIONS

This application claims the benefit of priority under 35 U.S.C. §119(e) of U.S. Provisional Application No. 62/048,519 entitled “Multilayer Perceptron For Dual SIM Dual Active Interference Cancellation” filed Sep. 10, 2014, Provisional Application No. 62/106,755 entitled “Multi-Model Radial Basis Function Neural Network for Dual SIM Dual Active Interference Cancellation” filed Jan. 23, 2015, U.S. Provisional Application No. 62/106,751 entitled “Radial Basis Function Neural Network for Dual SIM Dual Active Interference Cancellation” filed Jan. 23, 2015, U.S. Provisional Application No. 62/106,756 entitled “Banked Radial Basis Function Neural Network for Dual SIM Dual Active Interference Cancellation” filed Jan. 23, 2015, and U.S. Provisional Application No. 62/106,764 entitled “Multi-Model Block Least Squares/Radial Basis Function Neural Network for Dual SIM Dual Active Interference Cancellation” filed Jan. 23, 2015, the entire contents of all of which are hereby incorporated by reference.

### BACKGROUND

Some wireless communication devices—such as smart phones, tablet computers, laptop computers, and routers—contain hardware and/or software elements that provide access to multiple wireless communication networks simultaneously. For example, a wireless communication device can have one or more radio frequency communication circuits (or “RF chains”) for accessing one or more wireless local area networks (“WLANs”), wireless wide area networks (“WWANs”), and/or global positioning systems (“GPS”). When multiple reception (“Rx”) and/or transmission (“Tx”) operations are implemented simultaneously, i.e., co-exist, on a wireless communication device, these operations may interfere with each other.

### SUMMARY

The methods and apparatuses of various embodiments provide circuits and methods for managing interference in a multi-technology communication device. Embodiment methods may include receiving an aggressor signal at an input layer of a radial basis function (RBF) neural network, generating an aggressor kernel from the aggressor signal, executing a nonlinear radial basis function on the aggressor kernel at a hidden layer to produce multiple hidden layer outputs, augmenting the multiple hidden layer outputs with weight factors at an intermediate layer of the RBF neural network to produce augmented hidden layer outputs, infusing the augmented hidden layer outputs with infusion factors at an intermediate layer of the RBF neural network to produce infused hidden layer outputs, linearly combining the infused hidden layer outputs at the intermediate layer to produce combined hidden layer outputs, and executing a linear filter function on the combined hidden layer outputs at an output layer of the RBF neural network to obtain estimated nonlinear interference.

Some embodiments may further include determining an error of the estimated nonlinear interference, determining whether the error of the estimated nonlinear interference exceeds an efficiency threshold; and canceling, the estimated nonlinear interference from a victim signal. Such embodiments may further include training the weight factors to reduce an error of the estimated nonlinear interference. In such embodiments training the weight factors to reduce an error of the estimated nonlinear interference may include training weight factors in response to determining that the error of the estimated nonlinear interference exceeds the efficiency threshold, and canceling the estimated nonlinear interference from the victim signal may include canceling the estimated nonlinear interference from the victim signal in response to determining that the error of the estimated nonlinear interference does not exceed the efficiency threshold. Some embodiments may further include training the weight factors using a least squares method.

Some embodiments may further include training centroids of each node of the radial basis function prior to execution of the function.

In some embodiments, the linear filter function may be a finite impulse response filter. In some embodiment, the linear filter function may have a Hammerstein structure.

In some embodiments the radial basis function may be Gaussian.

In some embodiments, the received aggressor signal may represent an aggressor signal of the multi-technology communication device at a specific instance in time.

In some embodiments, generating an aggressor kernel may further include separating the aggressor signal into a real value component and an imaginary value component, and executing a kernel function on the real value component and imaginary value component to obtain an aggressor kernel having a real value kernel component and an imaginary value kernel component.

In some embodiments, the aggressor kernel may be a set of non-linear inputs derived from the received aggressor signal.

Some embodiments may further include canceling the estimated nonlinear interference from a victim signal. Such embodiments may further include decoding the victim signal after canceling the estimated nonlinear interference from the victim signal.

Some embodiments may further include training a second set of weight factors using the weight factors of the intermediate layer, in which the second set of weight factors may be associated with the linear filter function.

In some embodiments, the mobile communication device may perform the operations of augmenting the multiple hidden layer outputs with weight factors, infusing with the infusion factors, and linearly combining in a single function.

In some embodiments, the infusion factors may be the aggressor kernel. In some embodiments, the infusion factors may be the aggressor signal. In such embodiments, the infusion factors may include a real component of the aggressor signal and an imaginary component of the aggressor signal.

Embodiments include a multi-technology communication device having an antenna configured to receive an aggressor signal at the multi-technology communication device, and a processor communicatively connected to the antenna and configured with processor-executable instructions to perform operations of one or more of the embodiment methods described above.

Embodiments include a multi-technology communication device having means for performing functions of one or more of the embodiment methods described above.

Embodiments include a non-transitory processor-readable medium having stored thereon processor-executable software instructions to cause a processor to perform operations of one or more of the embodiment methods described above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a communication system block diagram illustrating a network suitable for use with various embodiments.

FIG. 2 is a component block diagram illustrating various embodiments of a multi-technology wireless communications device.

FIG. 3 is a component block diagram illustrating an interaction between components of different transmit/receive chains in various embodiments of a multi-technology wireless communications device.

FIG. 4 is a component block diagram illustrating multi-model radial basis function neural network with Hammerstein structure for a nonlinear interference cancellation system in accordance with various embodiments.

FIG. 5 is a component block diagram illustrating layers of a multi-model radial basis function neural network with Hammerstein structure in accordance with various embodiments.

FIGS. 6A-B are functional block diagrams illustrating an interaction between components of a multi-model radial basis function neural network with Hammerstein structure in accordance with various embodiments.

FIG. 7 is a process flow diagram illustrating a method for canceling nonlinear interference using a multi-model radial basis function neural network with Hammerstein structure in various embodiments of a multi-technology wireless communications device in accordance with various embodiments.

FIG. 8 is a process flow diagram illustrating a method for estimating nonlinear interference using a multi-model radial basis function neural network with Hammerstein structure in a multi-technology wireless communications device in accordance with various embodiments.

FIG. 9 is a process flow diagram illustrating a method for training weight factors for use in a multi-model radial basis function neural network with Hammerstein structure in a multi-technology wireless communications device in accordance with various embodiments.

FIG. 10 is a component diagram of an example multi-technology wireless communication device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims or the claims.

The word “exemplary” is used herein to mean “serving as an example, instance, or illustration.” Any implementation described herein as “exemplary” is not necessarily to be construed as preferred or advantageous over other implementations.

The terms “computing device,” “mobile device,” and “wireless communication device” are used interchangeably herein to refer to any one or all of cellular telephones, smartphones, personal or mobile multi-media players, personal data assistants (PDAs), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor and wireless communication circuitry. As used herein, the terms “multi-technology communication device” and “multi-technology communication device” refer to a wireless communication device that supports access to at least two mobile communication networks. While the various embodiments are particularly useful for mobile devices, such as smartphones, the embodiments are generally useful in any electronic device that implements radio hardware in close proximity to other hardware.

Descriptions of the various embodiments refer to multi-technology communication devices for exemplary purposes. However, the embodiments may be suitable for any multiple-technology (multi-technology) wireless communication device that may individually maintain a plurality of connections to a plurality of mobile networks through one or more radio communication circuits. For example, the various embodiments may be implemented in multi-SIM multi-active devices of any combination of number of subscriber identity modules (SIM) and concurrently active subscriptions. Moreover, a SIM may not be required for a wireless communication device to implement the various embodiments, which may apply to any form of wireless communication.

In a wireless communication device with multiple RF chains, the antennas of the RF chains may be in close proximity to each other. This close proximity may cause one RF chain to desensitize or interfere with the ability of another during the simultaneous use of the RF chains. Receiver desensitization (“desense”), or degradation of receiver sensitivity, may result from noise interference of a nearby transmitter. In particular, when two radios are close together with one transmitting on the uplink (the “aggressor”) and the other receiving on the downlink (the “victim”), signals from the transmitter may be picked up by the receiver or otherwise interfere with reception of a weaker signal (e.g., from a distant base station). As a result, the received signals may become corrupted and difficult or impossible for the victim to decode. In particular, desense of received signals presents a design and operational challenge for multi-radio devices due to the proximity of transmitter and receiver.

Multi-technology devices enable a user to connect to different mobile networks (or different accounts on the same network) while using the same multi-technology communication device. For example, a multi-technology communication device may connect to GSM, TDSCDMA, CDMA2000, WCDMA and other radio frequency networks. In the various embodiments, multi-technology communication devices may also include two RF chains so that each network communication supported by each RF chain can be accomplished concurrently.

However, multi-technology devices can suffer from interference between two communications being accomplished concurrently, such as when one communication session is transmitting (“Tx”) at the same time as another communication session is attempting to receive (“Rx”). As used herein, the term “victim” refers to the communication service or subscription suffering from interference at a given instant, and the term “aggressor” refers to the communication service or subscription whose Rx or Tx actions are causing the interference. In an example multi-technology communication device, the victim may be attempting to receive RF signals from a network while the aggressor attempts to transmit RF signals to another network. In an example of such interference, an aggressor's transmissions may de-sense the victim's reception, in which case the victim may receive the aggressor's transmissions that act as noise and interfere with the victim's ability to receive wanted RF signals.

In multi-technology communication devices, an aggressor's transmissions may cause severe impairment to the victim's ability to receive transmission. This interference may be in the form of blocking interference, harmonics, intermodulation, and other noises and distortion. Such interference may significantly degrade the victim's receiver sensitivity, link to a network, voice call quality and data throughput. These effects may result in a reduced network capacity for the affected communication service or subscription. The aggressor's transmission may also cause the victim to experience a receiver sensitivity that is drastically degraded, call quality degradation, higher rates for call drops and radio link failures, and data throughput degradation, which may potentially cause the victim to lose a data connection.

Nonlinear signals of the RF chains may be to blame for desense of received signals. Often the Tx/aggressor signal frequency is a fraction of the Rx/victim signal frequency. However, multiple aggressor signals may constructively combine to form a harmonic aggressor signal to the victim signal. The harmonic aggressor signal may be strong enough to cause nonlinear interference of the victim signal.

In order to recover information from the victim signal, various circuits and processing methods may be used to remove or subtract the interfering signals from the received victim signal. However, removing or subtracting nonlinear interference from a victim signal is particularly problematic for devices having multiple RF chain, such as multi-SIM multi-active (“MSMA”) devices and for Long-Term Evolution (“LTE”) carrier aggregation, because interference experienced on one RF chain may come from multiple RF sources and thus may have unpredictable signal form. Current techniques for removing nonlinear interference from a victim signal are case specific, requiring the communications device to have knowledge of the communication technology used for the transmission and reception of signals, and the kind of interference the aggressor signal is causing.

The various embodiments include methods for removing nonlinear interference from a victim signal in digital communications by using a neural network analysis method to estimate the coefficients of the signal to be removed before a received signal is decoded. In particular, the neural network may implement supervised learning using radial basis function with Hammerstein structure (e.g., a linear filter) to dynamically estimate an interference of the aggressor signals on the victim signal to be removed from the victim signal so that it may be decoded. An absolute calculation of the nonlinear interference may be mathematically difficult. Accordingly, the various embodiments provide methods that may be implemented in cost effective circuits and processing algorithms to provide an effective estimate of the interference, which when subtracted from the victim signal results in significant improvement in the recovered signal.

In various embodiments, a mobile device may use the neural network method combined with a linear filter function to estimate a function of the nonlinear interference from a set of known aggressor reference signals and a victim reference signal without having to know the type of communication technology or type, source or form of interference. The set of aggressor reference signals may be obtained from the RF chain on the mobile device supporting the aggressor reference signals. The victim reference signal may be obtained from the RF chain on the mobile device supporting the victim reference signal. These known signals may be received by the neural network at an input layer. In various embodiments, the aggressor reference signal may be a complex signal that may be divided into one or more real and imaginary aggressor signals. In various embodiments, the aggressor reference signal may be used to generate a dominant kernel of aggressor signals, which may be divided into one or more real and imaginary aggressor kernels and received by the neural network at the input layer in place of the aggressor reference signal. From the input layer, the neural network may generate an aggressor kernel, and may pass the aggressor kernel to a hidden layer of the neural network. From the nodes of the hidden layer, the aggressor kernel may be passed to an intermediate layer. In the intermediate layer, the aggressor kernel may be augmented using weight factors. The augmented aggressor kernel may be linearly combined for each node of the hidden layer. An output the intermediate layer may be passed to an output layer. All of the outputs of the intermediate layer may again be augmented by a second set of weight factors and linearly combined. Additionally, the aggressor signal may be passed from the input layer directly to an intermediate layer. Thus, the aggressor signal may bypass the hidden layer. In this manner, the aggressor signal provides a linear infusion that may be augmented with a weighted hidden layer output during or prior to a linear combination. An output of the intermediate layer may be an estimation of a jammer signal distorting the victim signal an estimated nonlinear interference, from which a function of the nonlinear interference may be determined. The estimated nonlinear interference may then be removed from a received victim signal.

In various embodiments, the weight factors used to estimate the function of the nonlinear interference may be trained using the linear filter function of the output layer and a corresponding second set of one or more weight factors. The delay elements of the linear filter function and associated weight factors may be set to a default “empty” setting and reference aggressor signals processed through the linear filter function. A result of executing the empty linear filter function on the reference aggressor signals may be the intermediate layer weights. The trained weight factors may be updated as needed in the multi-model radial basis function neural network with Hammerstein Structure to increase the accuracy of the estimated nonlinear interference.

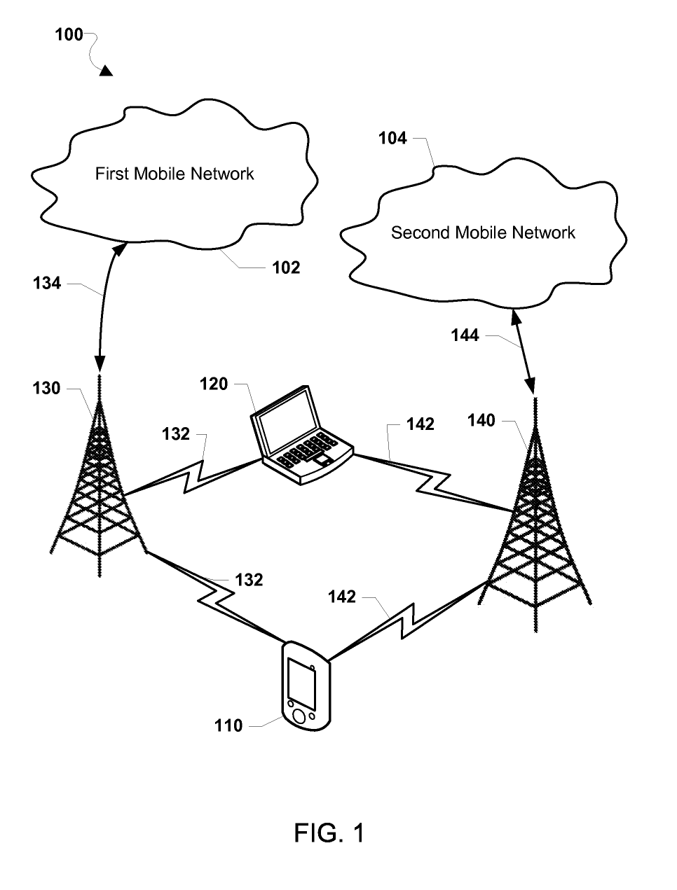

The various embodiments may be implemented in wireless communication devices that operate within a variety of communication systems 100, such as at least two mobile telephony networks, an example of which is illustrated in FIG. 1. A first mobile network 102 and a second mobile network 104 are typical mobile networks that include a plurality of cellular base stations 130 and 140. A first multi-technology communication device 110 may be in communication with the first mobile network 102 through a cellular connection 132 to a first base station 130. The first multi-technology communication device 110 may also be in communication with the second mobile network 104 through a cellular connection 142 to a second base station 140. The first base station 130 may be in communication with the first mobile network 102 over a connection 134. The second base station 140 may be in communication with the second mobile network 104 over a connection 144.

A second multi-technology communication device 120 may similarly communicate with the first mobile network 102 through a radio based communication connection such as a cellular connection 132 to a first base station 130. The second multi-technology communication device 120 may communicate with the second mobile network 104 through a radio communication connection such as a cellular connection 142 to the second base station 140. Cellular connections 132 and 142 may be made through two-way wireless communication links, such as 4G, 3G, CDMA, TDSCDMA, WCDMA, GSM, and other mobile telephony communication technologies. Other radio communication connections may include various other wireless connections, including WLANs, such as Wi-Fi based on IEEE 802.11 standards, and wireless location services, such as GPS. For example, the first wireless communications device may transmit and receive Wi-Fi communications from a network resource such as a router. Similarly, the wireless communications device may transmit and receive wireless communications with multiple Bluetooth enabled devices such as peripheral devices (e.g., keyboards, speakers, displays) as well as the second wireless communications device. The transmission and receipt of wireless communications over any and all of these radio resources may result in desense on victim signals during overlapping periods of transmission.

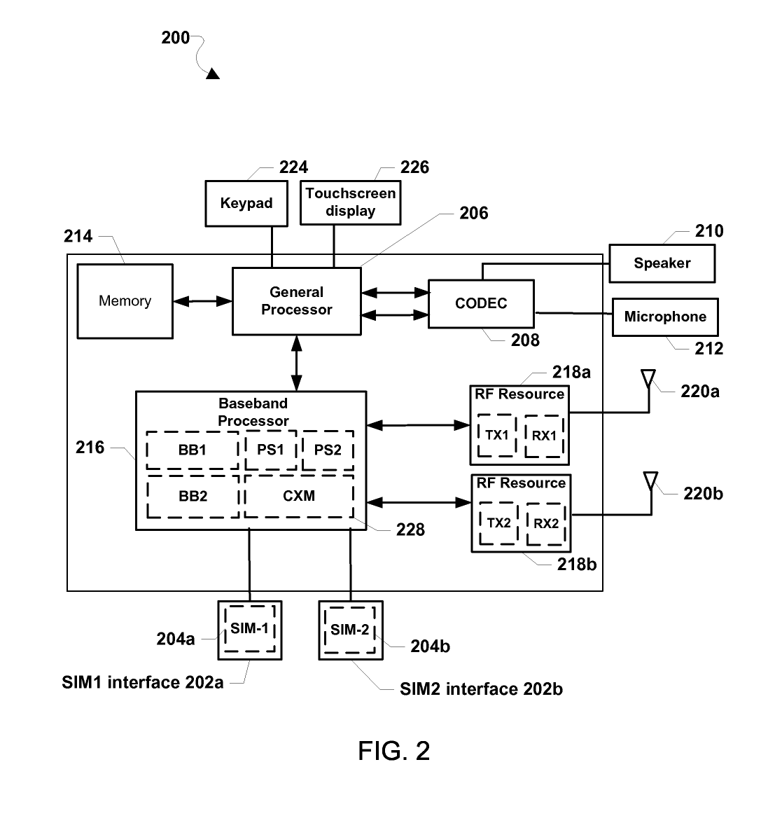

FIG. 2 illustrates various embodiments of a multi-technology communication device 200 (e.g., 110, 120 in FIG. 1) that are suitable for implementing the various embodiments. With reference to FIGS. 1 and 2, the multi-technology communication device 200 may include a first SIM interface 202a, which may receive a first identity module SIM-1 204a that is associated with a first subscription. The multi-technology communication device 200 may also include a second SIM interface 202b, which may receive a second identity module SIM-2 204b that is associated with a second subscription.

A SIM in the various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM may have a CPU, ROM, RAM, EEPROM and I/O circuits. A SIM used in the various embodiments may contain user account information, an international mobile subscriber identity (IMSI), a set of SIM application toolkit (SAT) commands and storage space for phone book contacts. A SIM may further store a Home Public-Land-Mobile-Network (HPLMN) code to indicate the SIM card network operator provider. An Integrated Circuit Card Identity (ICCID) SIM serial number may be printed on the SIM for identification.

Each multi-technology communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain.

The memory 214 may store operating system (OS), as well as user application software and executable instructions. The memory 214 may also store application data, such as an array data structure.

The general purpose processor 206 and memory 214 may each be coupled to at least one baseband modem processor 216. Each SIM in the multi-technology communication device 200 (e.g., SIM-1 202a and SIM-2 202b) may be associated with a baseband-RF resource chain. Each baseband-RF resource chain may include the baseband modem processor 216 to perform baseband/modem functions for communications on a SIM, and one or more amplifiers and radios, referred to generally herein as RF resources 218a, 218b. In some embodiments, baseband-RF resource chains may interact with a shared baseband modem processor 216 (i.e., a single device that performs baseband/modem functions for all SIMs on the wireless device). Alternatively, each baseband-RF resource chain may include physically or logically separate baseband processors (e.g., BB1, BB2).

In some embodiments, the baseband modem processor 216 may be an integrated chip capable of managing the protocol stacks of each of the SIMs or subscriptions (e.g., PS1, PS2) and implementing a co-existence manager software 228 (e.g., CXM). By implementing modem software, subscription protocol stacks, and the co-existence manager software 228 on this integrated baseband modem processor 216, thread based instructions may be used on the integrated baseband modem processor 216 to communicate instructions between the software implementing the interference prediction, the mitigation techniques for co-existence issues, and the Rx and Tx operations.

The RF resources 218a, 218b may be communication circuits or transceivers that perform transmit/receive functions for the associated SIM of the wireless device. The RF resources 218a, 218b may be communication circuits that include separate transmit and receive circuitry, or may include a transceiver that combines transmitter and receiver functions. The RF resources 218a, 218b may be coupled to a wireless antenna (e.g., a first wireless antenna 220a and a second wireless antenna 220b). The RF resources 218a, 218b may also be coupled to the baseband modem processor 216.

In some embodiments, the general purpose processor 206, memory 214, baseband processor(s) 216, and RF resources 218a, 218b may be included in the multi-technology communication device 200 as a system-on-chip. In other embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the multi-technology communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive a selection of a contact from a contact list or receive a telephone number. As another example, the request to initiate the outgoing call may be in the form of a voice command received via the microphone 212. Interfaces may be provided between the various software modules and functions in multi-technology communication device 200 to enable communication between them, as is known in the art.

In some embodiments, the multi-technology communication device 200 may instead be a single-technology or multiple-technology device having more or less than two RF chains. Further, various embodiments may implement, single RF chain or multiple RF chain wireless communication devices with fewer SIM cards than the number of RF chains, including without using any SIM card.

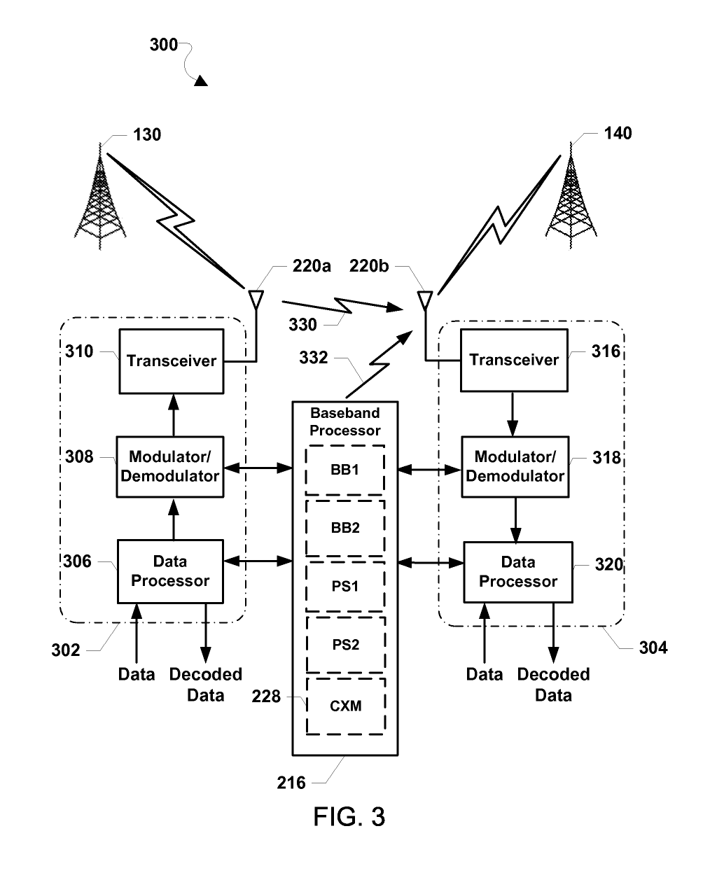

FIG. 3 is a block diagram of a communication system 300 and illustrates embodiment interactions between components of different transmit/receive chains in a multi-technology wireless communications device. With reference to FIGS. 1-3, for example, a first radio technology RF chain 302 may be one RF resource 218a, and a second radio technology RF chain 304 may be part of another RF resource 218b. In some embodiments, the first and second radio technology RF chains 302, 304 may include components operable for transmitting data. When transmitting data, a data processor 306, 320 may format, encode, and interleave data in preparation for transmission. A modulator/demodulator 308, 318 may modulate a carrier signal with encoded data, for example, by performing Gaussian minimum shift keying (GMSK). One or more transceiver circuits 310, 316 may condition the modulated signal (e.g., by filtering, amplifying, and up-converting) to generate a RF modulated signal for transmission. The RF modulated signal may be transmitted, for example, to the base station 130, 140 via an antenna, such as the antenna 220a, 220b.

The components of the first and second radio technology RF chains 302, 304 may also be operable to receive data. When receiving data, the antenna 220a, 220b may receive RF modulated signals from the base station 130, 140 for example. The one or more transceiver circuits 310, 316 may condition (e.g., filter, amplify, and down-convert) the received RF modulated signal, digitize the conditioned signal, and provide samples to the modulator/demodulator 308, 318. The modulator/demodulator 308, 318 may extract the original information-bearing signal from the modulated carrier wave, and may provide the demodulated signal to the data processor 306, 320. The data processor 306, 320 may de-interleave and decode the signal to obtain the original, decoded data, and may provide decoded data to other components in the wireless device.

Operations of the first and second radio technology RF chains 302, 304 may be controlled by a processor, such as the baseband processor(s) 216. In the various embodiments, each of the first and second radio technology RF chains 302, 304 may be implemented as circuitry that may be separated into respective receive and transmit circuits (not shown). Alternatively, the first and second radio technology RF chains 302, 304 may combine receive and transmit circuitry (e.g., as transceivers associated with SIM-1 and SIM-2 in FIG. 2).

As described, interference between the first and second radio technology RF chains 302, 304, such as de-sense and interpolation, may cause the desired signals to become corrupted and difficult or impossible to decode. For example, a transmission signal 330 sent by the first radio technology RF chain 302 may be errantly received by the second radio technology RF chain 304. In addition, electronic noise 332 from circuitry, such as the baseband processor 216, may also contribute to interference on the first and second radio technology RF chains 302, 304. To avoid such interference, the multi-technology communication device may implement various embodiment algorithms to estimate a nonlinear interference caused by the transmissions signal 330 and cancel the estimated nonlinear interference from victim signals received by the second radio technology RF chain 304.

For the purpose of providing a clear disclosure, signals received by a wireless communications device will be referred to as victim signals. However, victim signals may also be transmission signals experiencing desense caused by incoming received signals.

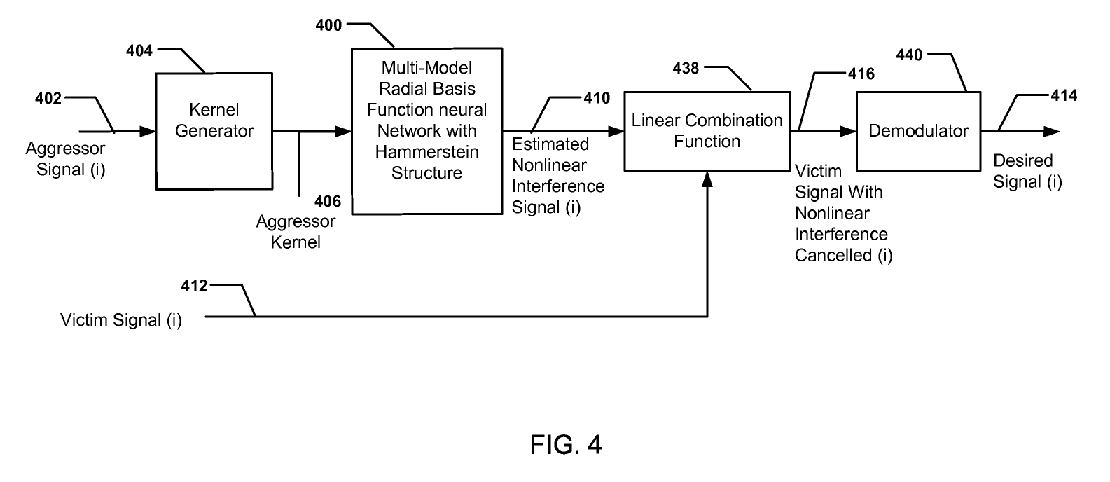

The various embodiments provide efficient algorithms that may be implemented in circuitry, in software, and in combinations of circuitry and software for estimating the nonlinear interference present in a victim signal without requiring a complete understanding or rigorous mathematical model of the aggressor signal or sources of the nonlinear interference. The embodiment algorithms are premised upon a general mathematical model of the nonlinear interferences, which for completeness is described below with reference to equations 1-3. These equations are not necessarily directly solvable, and provide a model for structuring that nonlinear interference cancellation system according to various embodiments described below beginning with FIG. 4.

In this mathematical model, the actual nonlinear interference signal is modeled as the interference experienced by a victim signal as a result of one or more aggressor signal(s) z(i). In this model, the actual nonlinear interference signal L(i) caused by one or more hypothetical aggressor signal(s) z(i) on a hypothetical victim signal at a time “i” may be represented by the function:

L(i)=\sqrt{JNR}·J(z(i)) [Eq. 1]

where JNR is a jammer to noise ratio (a value that could be measured at time i) and J(z(i)) is a Jacobian matrix of all hypothetical aggressor signals z(i). JNR is a value that can be calculated based on measurements but is not required in the embodiment algorithms.

Similarly, the estimated nonlinear interference signal \hat{L}(i) for a time “i” may be expressed as:

\hat{L}(i)=\sqrt{JNR}·Ĵ(z(i)) [Eq. 2]

where JNR is again the jammer to noise ratio and Ĵ(z(i)) is a Jacobian matrix of all aggressor signals z(i) (discussed in detail with reference to FIGS. 4-6A below). The estimated function \hat{L}(i) is an estimate of the actual nonlinear interference signal L(i) as discussed above. This estimated nonlinear interference signal \hat{L}(i) may be the result of manipulation of the aggressor signal z(i) by the radial basis function neural network with Hammerstein structure according to various embodiments as described below.

A victim signal y(i), may be the signal actually received by the multi-technology wireless communications device and may be degraded as a result of interference from the one or more aggressor signals z(i). The victim signal y(i) for the time “i” received by the multi-technology wireless communications device may be represented as the function:

y(i)=\sqrt{SNR}·x(i)+\sqrt{JNR}·J(z(i))+v(i) [Eq. 3]

where elements of the victim signal y(i) may be expressed in terms of the signal-to-noise ratio (SNR), the intended receive signal represented as a function x(i), the jammer-to-noise ratio (JNR) of equation 2, J(z(i) is the Jacobian matrix of all aggressor signals z(i), and a noise in the victim signal, such as thermal noise and inter-device interference, represented by the function v(i). As with equations 1 and 2 above, the victim signal in equation 3 is provided as a mathematical representation illustrating the relationship between the various signals.

Theoretically, the intended received signal x(i) may be obtained by rearranging the terms in Equation 3 to solve for x(i). A direct solution of these model equations may not be feasible in real time, particularly within mobile communication devices that have limited processing power. Therefore, the various embodiments employ a multi-model radial basis function neural network with Hammerstein structure to generate an estimate of the nonlinear interference signal L(i) without directly solving equation 1-3.

FIG. 4 illustrates an example nonlinear interference cancellation system including a multi-model radial basis function neural network with Hammerstein structure 400 that may be used to remove an estimate of the nonlinear interference from a victim signal in accordance with various embodiments. With reference to FIGS. 1-4, the radial basis function neural network with Hammerstein structure 400 may be implemented in a multi-technology wireless communications device (e.g., 110, 120, 200 in FIGS. 1 and 2) in software, general processing hardware, dedicated hardware, or a combination of any of the preceding. The multi-model radial basis function neural network with Hammerstein structure 400 may be configured to receive an aggressor signal 402 and a victim signal 412 at a time “i”. The radial basis function neural network with Hammerstein structure 400 may be configured to produce an estimated nonlinear interference signal 410 for the time “i”.

In various embodiments, the multi-model radial basis function neural network with Hammerstein structure 400 may help identify an intended receive signal x(i), that the signal the communications device would have received but for the experienced interference, from among the elements of the actually received victim signal 412 y(i). Given an aggressor signal 402 z(i), the radial basis neural network with Hammerstein structure 400 may implement radial basis function machine learning algorithms combined with linear filtering to produce an estimated nonlinear interference signal 410 for time “i” that may be cancelled from the victim signal 412.

The estimated nonlinear interference signal 410 for the time “i” may be used by a linear combination function 438 to cancel the estimated nonlinear interference signal 410 from the victim signal 412. For example, the linear combination function 438 may subtract, add, or otherwise mathematically manipulate portions of the estimated nonlinear interference signal 410 affecting the victim signal 412. Thus, unnecessary elements of the victim signal 412 caused by aggressor signal 402 interference may be removed from the victim signal 412 and elements obscured by aggressor signal 402 interference may be recaptured. The result of the linear combination function 438 may be the victim signal with the nonlinear interference cancelled 416. A demodulator 440 may receive the victim signal with the nonlinear interference cancelled 416 and demodulate it to produce the desired signal 414.

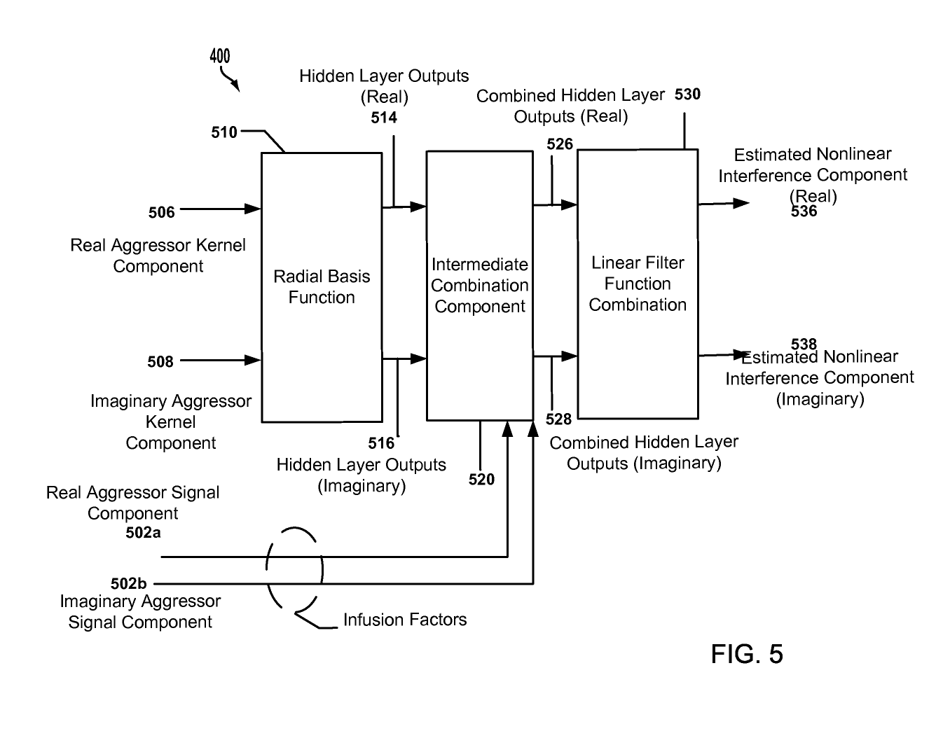

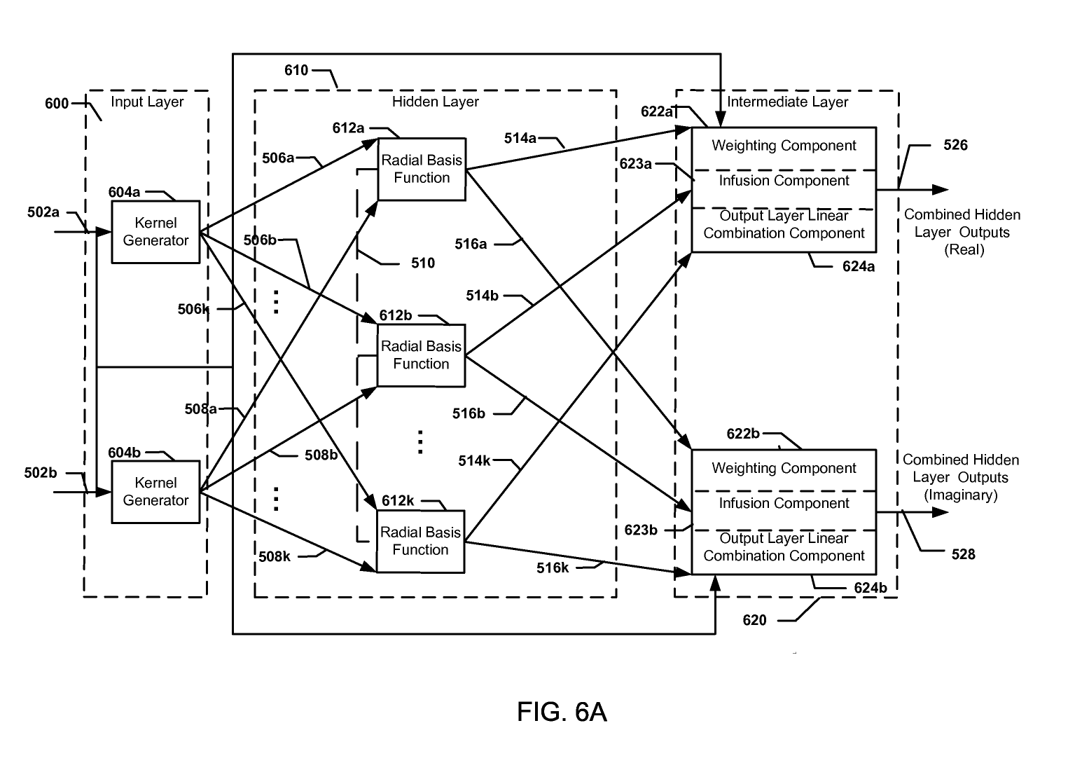

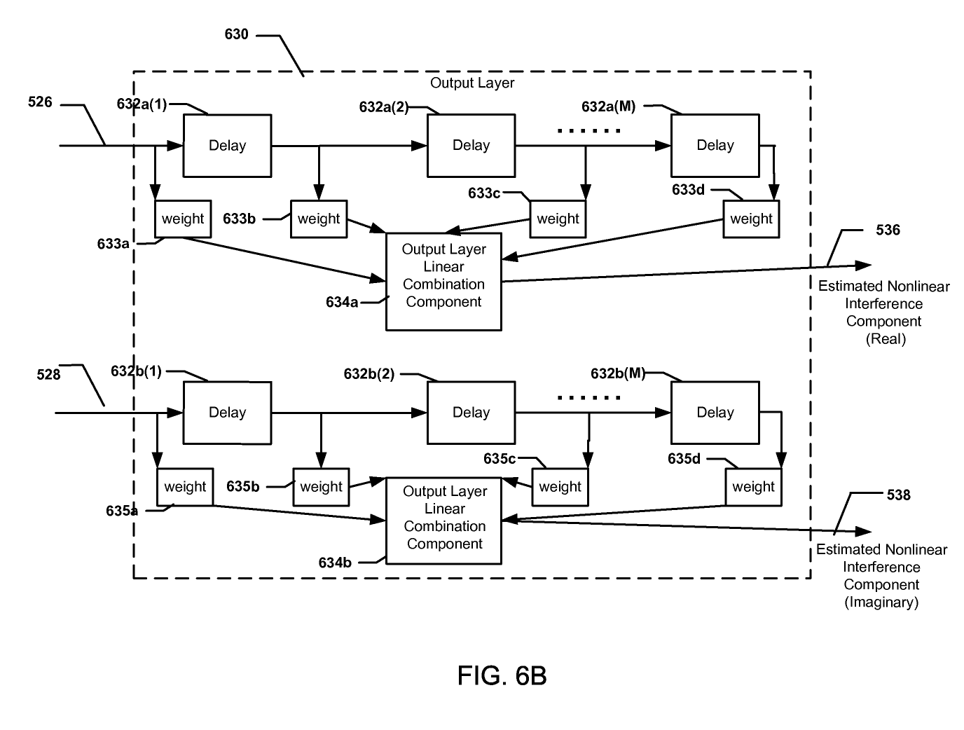

In various embodiments, the multi-model radial basis function neural network with Hammerstein structure 400 may include computer implementations of neural network machine learning algorithms. One or more aggressor signals 402 z(i) may be provided as input to the multi-model radial basis function neural network with Hammerstein Structure 400 as will be discussed in greater detail with reference to FIGS. 5-6A below. The aggressor input(s) may be manipulated by the multi-model radial basis function neural network with Hammerstein structure 400 in a series of mathematical operations and estimations to generate the estimated nonlinear interference signal 410. Because of the mathematical complexity associated with calculation of an actual nonlinear interference signal, radial basis function machine learning algorithms and linear filter functions (e.g., Hammerstein structure) may be implemented to produce an estimate of an experienced nonlinear interference signal such as the estimated nonlinear interference signal 410. As such, the various formulas described herein are mathematical representations of actual and estimated signals that are utilized or produced by the radial basis function neural network with Hammerstein structure 400. These mathematical representations may not be actively calculated by the radial basis function neural network with Hammerstein structure 400, but are provided to enable one of ordinary skill in the art to realize the relationships between elements of the various signals as they are manipulated by the operations described herein.

As discussed with reference to equations 1 and 2 above, the estimated nonlinear interference signal 410 may be described in terms of one or more aggressor signals 402 z(i). Thus, the production of the estimated nonlinear interference signal 410 may depend on the manipulation of the aggressor signals 402 by the multi-model radial basis function neural network with Hammerstein structure 400. In some embodiments, the multi-model radial basis function neural network 400 may accept the result of a kernel function executed on the aggressor signal 402 (i.e., aggressor kernel(s)) by a kernel generator 404. These embodiments will be discussed in greater detail with reference to FIGS. 5-6B below.

Generating an estimated nonlinear interference signal 410 for the time “i” may be accomplished by the radial basis function neural network with Hammerstein structure 400 in a semi-blind and universal manner. In other words, the radial basis function neural network with Hammerstein structure 400 may calculate the estimated nonlinear interference signal 410 knowing some information about the radio access technology used by the multi-technology wireless communications device and/or the kind of interference occurring on the victim signal 412. This information may include the radio band of the aggressor and/or victim signal and other transmission information. In embodiments in which the aggressor signal 402 is converted into an aggressor kernel, the order of the kernel function may be dictated by the transmission information. For example, in various embodiments, aggressor signals transmitted on a particular radio band may require manipulation using a kernel function of order “b” to produce an aggressor kernel.

The multi-model radial basis function neural network with Hammerstein structure 400 may be configured to utilize the complex aggressor kernel to produce an estimated nonlinear interference signal 410 for the time “i”. As described, the aggressor signal 402 may be represented as a function z(i) for the time “i”. The kernel generator 404 may include one of various kernel functions such as an harmonic or exponential expansion of order “r”. A kernel function may be applied to all or a portion of the aggressor signal 402 to produce an aggressor kernel 406. The resulting aggressor kernel 406 may have a complex structure with both real and imaginary components. Thus, the aggressor kernel \hat{z}(i) may be represented as:

\hat{z}_{Real}(i)=Real part of ker(z(i)) [Eq. 4a]

\hat{z}_{Imaginary(}i)=Imaginary part of ker(z(i)) [Eq. 4b]

where ker(z(i)) is the application of a selected kernel function on the aggressor signal 402 z(i) by the kernel generator 404.

As discussed with reference to FIG. 4 and with further reference to FIG. 5, the aggressor signal 402, the real aggressor kernel component 506 and the imaginary aggressor kernel component 508 may be received at the radial basis function neural network with Hammerstein structure 400 and used to produce the real jammer signal estimate component and an imaginary jammer signal estimate component (i.e., combined hidden layer outputs 526, 528). The linear filter 530 may receive the real jammer signal estimate component and an imaginary jammer signal estimate component and produce the estimated nonlinear interference component (real) component 536 and the estimated nonlinear interference component (imaginary) component 538.

FIG. 5 illustrates an example of the flow of inputs and outputs through the multi-model radial basis function neural network with Hammerstein structure 400 FIG. 4 in accordance with various embodiments. With reference to FIGS. 1-5, the multi-model radial basis function neural network with Hammerstein structure 400 may include a radial basis function 510, an intermediate combination 520, and linear filter function 530, which may further the calculation of the estimated nonlinear interference signal (e.g., 410 in FIG. 4) for time “i”. The radial basis function 510 may include one or more nodes (i.e., there may be 1 to “k” nodes). The number of nodes may be dictated by the level of accuracy desired for the estimated nonlinear interference. Larger quantities of nodes may provide more accurate estimates of nonlinear interference signals, but may require greater computational resources.

In various embodiments, each node φₖ(i) of the radial basis function 510 may produce one or more hidden layer output signals (real) 514 and one or more hidden layer output signals (imaginary) 516. The hidden layer output signals 514, 516 and the aggressor signal 402 may be passed as an input to the intermediate combination component 520, which will be described in further detail with reference to FIGS. 6A-6C. Each node of the radial basis function 510 may be represented as:

$${ϕ}_{k} ( i ) = exp ( - \frac{{‖ \underline{z} ( i ) - {\underline{c}}_{k} ‖}^{2}}{2 {σ}_{k}^{2}} ) \qquad [ Eq . 5 ]$$

Where “k” is a current node number from t to a total number of nodes “K”, z(i) is an aggressor signal at time “I”, cₖ is a radial basis function centroid associated with node “k”, and σₖ² is a scalar constant referred to as the “spread” of the data distribution associated with node “k”. Equation 5 is a mathematical model of a representative radial basis function that may be used in the estimated of nonlinear interference signal 410 using an aggressor signal 402.

The number of nodes “K”, may be dictated by the scale of the neural network implementation (e.g., enterprise level networks having substantial interference issues may require larger numbers of nodes). In some embodiments, an aggressor kernel 406 generated from the aggressor signal 402 at time “i” may be a hidden layer input. The aggressor signal 402 may be separated into a real aggressor signal component 502a and an imaginary aggressor signal component 502b prior to or during the kernel generation process. The resultant aggressor kernel 406 may comprise a real aggressor kernel component 506 and an imaginary aggressor kernel component 508. In some embodiments the aggressor kernel 406 may be a vector. In such embodiments, the real aggressor kernel component 506 and the imaginary aggressor kernel component 508 may be treated as elements of a vector. Each node of the radial basis function 510 may produce a hidden layer output signal (real) 514 and hidden layer output (imaginary) 514, 516. Hidden layer output signals 514, 516 may be passed to an intermediate combination component 520 in the intermediate layer. Intermediate combination component 520 may also accept as input the aggressor signal 402 that may further be separated into real and imaginary aggressor signal components 502a, 502b. The hidden layer outputs 514, 516, a set of weight factors, and the real aggressor signal component 502a and an imaginary aggressor signal components 502b (infusion factors may be combined in an intermediate combination component 520 at the intermediate layer. In some embodiments, the output of the intermediate combination component 520 may be a combined hidden layer output (real) 526 and a combined hidden layer output (imaginary) 528. These combined hidden layer outputs 526, 528 may be passed to a linear filter function 530 of the output layer.

Each node of the radial basis function 510 may receive the real aggressor kernel component 506 and the imaginary aggressor kernel component 508. Execution of the radial basis function via each node of the function may produce a hidden layer output (real) 514 and a hidden layer output (imaginary) 516 for each node. In some embodiments, the hidden layer outputs 514, 516 may be augmented with one or more weight factors and a vector comprising the aggressor signal real and imaginary components. The hidden layer outputs may be augmented during or prior to being inputted into the intermediate combination component 520. The linear combination component 520 may sum, multiply or otherwise mathematically manipulate the augmented hidden layer outputs with weight factors to produce a combined hidden layer output (real) 526 and a combined hidden layer output (imaginary) 528. Thus, the combined hidden layer outputs 526, 528 ŝ_{Real}(i), ŝ_{Imaginary}(i) may be expressed in terms of the linear combination of the hidden layer outputs 514, 516φₖ(i) for a time “i” and the one or more weight factors wₚₖ. For each weight factor “w” associated with either a real aggressor kernel component 506 or an imaginary aggressor kernel component 508 “p” (where p=1 for real, and p=2 for imaginary), the current radial basis function node “k” may be any node from 1 to “K” for a radial basis function of “K” nodes. The combined hidden layer outputs 514, 516 may be represented by the following functions:

ŝ_{Real}(i)=[w_{1,Real}z_{Real}(i)+w_{1,Imaginary}z_{Imaginary}(i)+w_{1,1}φ₁+ . . . w_{1,K}φ_{K}] [Eq. 6a]

ŝ_{Imaginary}(i)=[w_{2,Real}z_{Real}(i)+w_{2,Imaginary}z_{imaginary}(i)+w_{2,1}w_{2,1}φ₁+ . . . w_{2,K}φ_{K}] [Eq. 6b]

where ŝ_{Real}(i) and ŝ_{Imaginary} (i) are combined hidden layer outputs, wₚₖ is a weight factor for a real/imaginary aggressor kernel components “p” of radial basis function node “k”, z_{Real}(i) and z_{Imaginary}(i) are real and imaginary aggressor signal components 502a, 502b, and φ₁(i) is a hidden layer output.

In an alternative embodiment, each node of the radial basis function 510 may receive the aggressor signal components 502a, 502b. The real kernel component 506 and the imaginary kernel component 508 may be passed directly to the intermediate combination component 520. Execution of the nodes of the radial basis function 510 may result in a hidden layer output (real) 514 and a hidden layer output (imaginary) 516 for each node. The hidden layer outputs 526, 528 may be augmented with one or more weight factors and a vector of aggressor kernel signal components, during or prior to the intermediate combination component 520. The intermediate combination component 520 may receive the hidden layer outputs 514, 516 and the aggressor kernel 506, 508, augment them with one or more weight factors. The augmented hidden layer outputs may be summed to produce a combined hidden layer output (real) 526 and combined hidden layer output (imaginary) 528. Thus in this embodiment, the intermediate combination component 520 may receive linear inputs and a kernel infusion. The combined hidden layer outputs 514, 516 for a radial basis function of “K” nodes for the time “i” may be represented by the functions:

ŝ_{Real}(i)=[w_{1,Real}\hat{z}_{Real}(i)+w_{1,Imaginary}\hat{z}_{Imaginary}(i)+w_{1,1}φ₁+ . . . w_{1,K}φ_{K}][Eq. 7a]

ŝ_{Imaginary}(i)=[w_{w,Real}\hat{z}_{Real}(i)+w_{2,Imaginary}\hat{z}_{Imaginary}(i)+w_{2,1}φ₁+ . . . w_{w,K}φ_{K}] [Eq. 7b]

where ŝ_{Real}(i) and ŝ_{Imaginary}(i) are combined hidden layer outputs, wₚₖ is a weight factor for a real/imaginary aggressor kernel components “p” of radial basis function node “k” (where p=1 for real, and p=2 for imaginary), \hat{z}_{Real}(i) and \hat{z}_{Imaginary}(i) are real and imaginary aggressor kernel components 506, 508, and φ₁(i) is a hidden layer output.

The combined hidden layer outputs 526, 528 may be used by a linear filter function component 530 of the output layer to produce an estimated nonlinear interference component (real) component 536 and an estimated nonlinear interference component (imaginary) 538. The linear filter function component 530 of the output layer, may augment and linearly combine the combined hidden layer outputs 526, 528. Augmenting and linearly combining the combined hidden layer outputs 526, 528 may produce complex components of an estimated nonlinear interference (i.e., estimated nonlinear interference (real) 536 and estimated nonlinear interference (imaginary) 538) that may be combined to produce an estimated nonlinear interference signal 410. The estimated nonlinear interference signal 410 may be used to cancel interference from a received victim signal.

The linear filter function component 530 may have a Hammerstein structure or other finite impulse response filter structure. The linear filter function component 530 may have “M” taps (wherein a tap is delay element/weight factor pair). The second set of weights may be represented by “a_{qm}” where “q” is the vector row of the vector representing the aggressor kernel (e.g., q=1 for real input or q=2 for imaginary input) and “m” is a current tap of a delay line of the output layer linear filter function having “M” taps. Results of the linear filter function component 530 may be the estimated nonlinear interference components 536, 538 \hat{L}_{Real}(i), \hat{L}_{Imaginary}(i) and may be expressed in terms of the combined hidden layer outputs 526, 528 and the second set of weight factors a_{qm}. Thus, the estimated nonlinear interference components 536, 538 for the time “i” may be represented by the following functions:

\hat{L}_{Real}(i)=Σₘ₌₀^{M-1}a_{1,m}ŝ_{Real}(i−m) [Eq. 8a]

\hat{L}_{Imaginary}(i)=Σₘ₌₀^{M-1}a_{2,m}ŝ_{Imaginary}(i−m) [Eq. 8b]

where \hat{L}_{Real}(i), \hat{L}_{Imaginary}(i) are estimated nonlinear intereference components 536, 538, “m” is a current tap of a linear filter function delay line having a total of “M” taps, a_{qm} is a weight factor for a real/imaginary aggressor kernel component “p”, and a combined hidden layer output ŝ_{Real}, ŝ_{Imaginary} 526, 528. The estimated nonlinear interference component (real) 536 and estimated nonlinear interference component (imaginary) 538 may be combined to produce an estimated nonlinear interference signal 410 \hat{L}(i). An estimated nonlinear interference signal 410 may be cancelled from the received victim signal 412 y(i) to obtain an intended receive signal “x(i)”. In various embodiments, the estimated nonlinear interference component (imaginary) 538 may be augmented by a Jacobian matrix prior to combination with the estimated nonlinear interference component (real) 536 to obtain the total estimated nonlinear interference. Thus, the estimated nonlinear interference signal may be represented by the function:

\hat{L}(i)=\hat{L}_{Real}(i)+j\hat{L}_{Imaginary}(i) [Eq. 9]

where \hat{L}(i) is an estimated nonlinear interference signal 410, \hat{L}_{Real}(i) and \hat{L}_{Imaginary}(i) are estimated real and imaginary nonlinear interference signal components 536, 438, and “j” is a Jacobian matrix that may be used to manipulate the orientation of elements within the estimated imaginary nonlinear interference component (imaginary) 538.

FIGS. 6A-6B illustrate interactions between components of a radial basis function and input layer of a multi-model radial basis function of a radial basis function neural network with Hammerstein structure (e.g., 400 in FIG. 4) in accordance with various embodiments. With reference to FIGS. 1-6B, the multi-model radial basis function neural network with Hammerstein structure 400 may include an input layer 600, a hidden layer 610, and an intermediate layer 620. For purposes of clarity, the multi-model radial basis function neural network with Hammerstein structure 400 is described with reference to a single aggressor signal; however, multiple aggressor signals may interfere with the victim signal and consequently multiple aggressor signals may be used to produce the estimated nonlinear interference signal.

The input layer 600 may receive the real and imaginary aggressor signal components 502a, 502b representing an aggressor signal 402 separated into a real aggressor signal component 502a and an imaginary aggressor signal component 502b. The aggressor signal components 502a, 502b may be passed to one or more kernel generators 604a, 604b. The one or more kernel generators 604a, 604b may apply a kernel function to the aggressor signal components 502a, 502b (i.e., the aggressor signal 402 separated into real and imaginary components) to produce an aggressor kernel having a real aggressor kernel component 506a-k and an imaginary aggressor kernel component 508a-k component. Each of the real aggressor kernel component 506a-k and imaginary aggressor kernel component 508a-k may be passed to each node 612a-k of the hidden layer 610. The real aggressor kernel components 506a-k may be passed to nodes 612a-k. Similarly, the imaginary aggressor kernel components 508a-k may be passed to and received by corresponding nodes 612a-k. In various embodiments, the number of instances of kernel component passes is not limited to three, and may scale with the number of radial basis function nodes implemented. The input layer 600 may also pass the aggressor kernel components 506a-k, 508a-k directly to the intermediate layer 620, bypassing the hidden layer 610.

In various embodiments, the radial basis function 510 may be trained prior to processing aggressor kernel components 506a-k, 508a-k. The multi-model radial basis function neural network with Hammerstein structure 400 may be trained by first estimating the centroids and spread. Centroid estimation may include use of a k-means clustering algorithm to produce a random sample of “K” centroids. The centroids may represent the distribution centers of “K” clusters. A set of sample aggressor signals may be passed to the nodes of the radial basis function 510 of the multi-model radial basis function neural network with Hammerstein structure 400. Results may be compared to determine an accuracy of centroid estimation. Centroids may be mathematically manipulated until the results converge.

The nodes 612a-612k of the hidden layer 610 may execute a radial basis function on received real kernel components 506a-k and imaginary aggressor kernel components 508a-k to produce hidden layer outputs φₚₖ(i). Each node 612a-k of the hidden layer 610 may pass the hidden layer outputs 514, 516 (e.g., [φ₁ₐ(i), . . . φ_{1c}(i)] and [φ₂ₐ(i), . . . φ_{2c}(i)]) to an intermediate layer 620. As with the aggressor kernel inputs 506a-k, 508a-k, the hidden layer outputs 514a-k, 516a-k may be complex. Thus, the hidden layer outputs 514a-k, 516a-k may include a hidden layer output (real) 514a-k and a hidden layer output (imaginary) 516a-k. There may be “K” hidden layer outputs (real) 514a-k and “K” hidden layer outputs (imaginary) 516a-k for a hidden layer 610 having “K” nodes.

At the intermediate layer 620, the hidden layer outputs (real) 514a-k and hidden layer outputs (imaginary) 516a-k may be augmented by weighting component 622a, 622b of the intermediate layer 620. The weighting components 622a, 622b may augment each of the hidden layer outputs 514a-k, 516a-k with one or more weight factors to produce augmented hidden layer outputs. In various embodiments, weighting component 622a may apply one or more weight factors to the hidden layer (real) outputs 514a-k. Similarly, weighting component 622b may apply one or more weight factors to the hidden layer outputs (imaginary) 516a-k. The weighting components 622a-b, and infusion components 633a-b may be individual components of the multi-model radial basis function neural network implemented with general purpose hardware, dedicated hardware, and/software, or the weighting components 622a-b may be incorporated into the intermediate layer linear combination components 624a-b. Thus the weighting components and the infusion components may be applied hidden layer outputs 514a-k, 516a-k prior to, during, or after summation by the intermediate layer linear combination components 624a-b. Augmentation and linear combination of the hidden layer outputs 514a-k, 516a-k may result in a single combined hidden layer output (real) 526 and a single combined hidden layer output (imaginary) 528, which may be passed to an output layer 630 for filtering.

At the intermediate layer 620, the hidden layer outputs (real) 514a-k and hidden layer outputs (imaginary) 516a-k, or augmented hidden layer outputs, may be infused with one or more infusion components 623a, 623b to produce infused hidden layer outputs. The infusion components 623a, 623b may augment the hidden layer outputs with one or more infusion factors, which may be the real and imaginary aggressor signal components 502a, 502b or the real and imaginary aggressor signal components 506, 508. The infusion factors may include the real and imaginary aggressor signal components 502a, 502b. In various embodiments, each of the hidden layer outputs (real) 514a-k and hidden layer outputs (imaginary) 516a-k may be augmented (i.e. infused) with both the real and imaginary aggressor signal components 502a, 502b. In some embodiments, the input layer may pass the real aggressor signal component 502a and the imaginary aggressor signal component 502b to the hidden layer as inputs and may pass the real aggressor kernel component 506 and imaginary aggressor kernel component 508 to the intermediate layer for use as infusion factors. In some embodiments, the infusion may include multiplication, summation, or other mathematical manipulation.

With reference to FIGS. 1-6B, the output layer 630 of the radial basis function neural network with Hammerstein structure 400 may be configured to filter the combined hidden layer outputs 526, 528 using a linear filter function component 530. Execution of the linear filter function component 530 on the combined hidden layer output (real) 526 and combined hidden layer output (imaginary) 528 may produce estimated nonlinear interference components 536, 538. In some embodiments, the output layer 630 may include a finite impulse response filter having a delay line 632a(1)-(M) for the combined hidden layer output (real) 526, and a delay line 632b(1)-(M) for the combined hidden layer output (imaginary) 528. A second set of weighting components 633a-d, 635a-d (where d may be equal to “M”) may augment the combined hidden layer outputs 526, 528 with a second set of one or more weight factors at each operation of the delay lines 632a(1)-(M), 632b(1)-(M). The linear filter function 530 may further include the output layer linear combination components 634a, 634b for the real and imaginary combined hidden layer outputs 526, 528 as they are sampled by the delay lines 632a(1)-(M), 632b(1)-(M), and augmented with the second weighting components 633a-d, 635a-d. Each operation of the delay lines and an associated weighting component is a “tap” of the linear filter function component 530. The linear filter may have “M” taps on each delay line and thus may have M-1 weighting components (i.e., d=M or d=M) for each delay line. A result of the output layer 630 may be an estimated nonlinear interference component (real) 536 and an estimated nonlinear interference component (imaginary) 538.

In an embodiment, the weighting components 633a-d, 635a-d of the output layer 630 may augment each of the combined hidden layer outputs 526, 528 with one or more weight factors during each iteration of the delay line of a linear filter function, such that after each augmentation the result is passed to one of the output layer linear combination components 634a, 634b. Execution of the linear filter function may produce an estimated nonlinear interference component (real) component 536 and an estimated nonlinear interference component (imaginary) 538.

In various embodiments, the weight factors may be trained prior to execution of the multi-model radial basis function neural network with Hammerstein structure 400. In some embodiments, weight training may utilize a least squares method. In some embodiments, initial weight training may include setting the output layer linear filter function taps to 1, 0,0 . . . 0, thereby indicating that the filter is empty. The intermediate layer weight factors “w’, may then be trained according to the functions:

y(i)=(φ(i)^{T}w+v(i) [Eq. 9a]

φ(i)=[φ₁(i)φ₂(i) . . . φₖ(i)]^{T} [Eq. 9b]

ŵ=(A^{T}(i)A(i))⁻¹ A^{T}(i)y(i) [Eq. 9c]

A(i)=[φ(i) φ(i−1) . . . φ(i+N-1)]^{T} [Eq. 9d]

where y(i) is a victim signal 412, φ(i)^{T} is a transposed matrix of hidden layer output signals for the time “i”, “w” are intermediate layer weight factors, and “A” is a matrix of hidden layer output signals for times “I” through “i+N-1” (N may be equal to “M” the number of delay line taps).

Once trained, the intermediate layer weight factors “w” may be used to train output layer weight factors “a” (i.e., linear filter function weight factors). The trained intermediate layer weight factors and a set of sample aggressor signals may be used to produce sample combined hidden layer outputs (s_{Real}(i), s_{Imaginary(i)). These sample combined hidden layer outputs may be passed to the linear filter function 530 of the output layer. The linear filter function component 530 may execute in the manner discussed above to train the output layer weight factors. In this manner, the output layer weighting components 633 may be trained according to the functions:}

y(i)=ŝ(i)^{T}a+n(i) [Eq. 10a]

ŝ(i)=[ŝ(i) ŝ(i−1) . . . ŝ(i−Mem)]^{T} [Eq. 10b]

â=(S^{T} (i)S(i))⁻¹ S^{T}(i)y(i) [Eq. 10c]

S(i)=[ŝ(i) ŝ(i−1) . . . ŝ(i+N-1)]^{T} Eq. 10d]

where y(i) is a victim signal 412, s(i)^{T}is a transposed matrix of combined hidden layer output signals for the time “i”, “a” are output layer weight factors, and “S” is a matrix of combined hidden layer output signals for times “I” through “i+N-1” (N may be equal to “M” the number of delay line taps).

As will be discussed in further detail, the radial basis function neural network with Hammerstein structure 400 may train the weight factors at different times to improve the accuracy of the estimated nonlinear interference signal. The estimated nonlinear interference may be cancelled or subtracted from the victim signal 412 so that the victim signal 412 may be decoded and understood by the multi-technology communications device.

In some embodiments, an error of the estimated nonlinear interference 410 may be compared to an error threshold to determine whether the error is acceptable. Determining that the error present in an estimation of the nonlinear interference signal is unacceptable may prompt the radial basis function neural network with Hammerstein structure 400 to train or retrain the weight factors to reduce the error in the estimated nonlinear interference signal 410. The weight factors may be trained using a variety of optimization algorithms, for example gradient descent, the Gauss-Newton algorithm, and the Levenberg-Marquardt algorithm. Training of the weight factors may be regressively executed to further reduce the error of the estimated nonlinear interference signal 410. In some embodiments, satisfactory weight factors may be reused for subsequent nonlinear interference estimations. The reuse of previously determined weight factors may be based on one or more parameters, such as time since the last adjustment of the weight factors, how the error in the estimated nonlinear interference 410 compares to the error threshold, and the like.

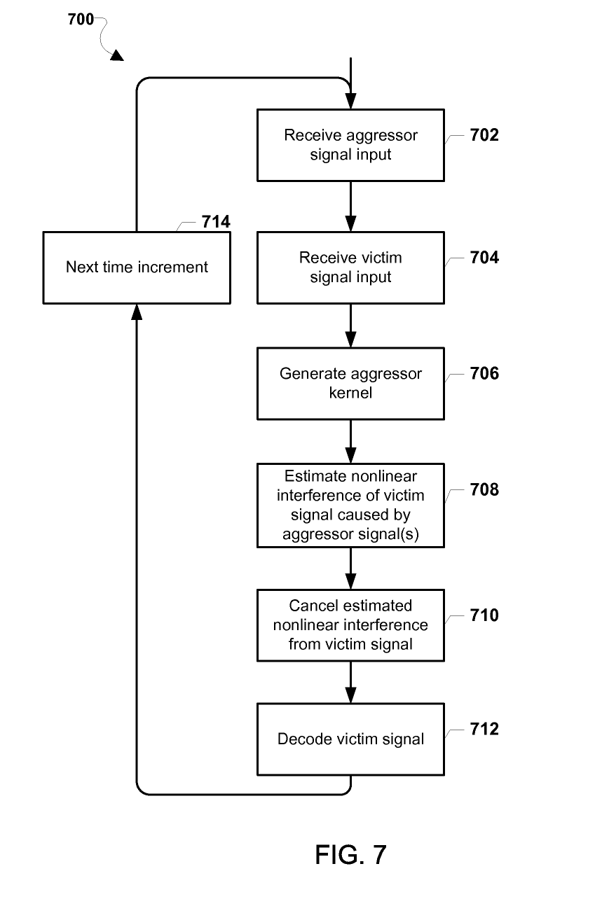

In the various examples, components of the radial basis function neural network are shown individually or in combination. It should be understood that these examples are not limiting and the various other configurations of the components are considered. For example, the nodes 612a-k and their components are illustrated as separate components. However, any of the nodes 612a-k and/or components may be embodied in combination with other components, and multiples of the same component may be embodied in a single component. FIG. 7 illustrates a method 700 for canceling nonlinear interference from a received signal using a multi-model radial basis function neural network with Hammerstein structure (e.g., 400 in FIG. 4) in a multi-technology wireless communications device in accordance with various embodiments. With reference to FIGS. 1-7, the method 700 may be executed in a computing device (e.g., 110, 120, 200 in FIGS. 1 and 2) using software, general purpose or dedicated hardware, or a combination of software and hardware, such as the general purpose processor 206 (FIG. 2), baseband processor 216, or the like. In one example, the method may be performed by a processor of the multi-technology communication device. In block 702, the multi-technology communication device may receive an aggressor signal. The aggressor signal may be received by a first radio access technology of the multi-technology communication device from a transmission of a second radio access technology of the same multi-technology communication device.

In block 704, the processor of the multi-technology communication device may receive a victim signal. The victim signal may be received by the first radio access technology of the multi-technology communication device from a transmitting source device separate from the multi-technology communication device. The victim signal may initially be unaffected by interference when transmitted from the transmitting source device. However, the victim signal may experience interference caused by the aggressor signal during transmission to the multi-technology communication device.

In block 706, the processor of the multi-technology communication device may generate a dominant aggressor kernel from the aggressor signal. The aggressor kernel may include a real component and an imaginary component. The aggressor signal received by the first radio access technology of the multi-technology communication device may be separated into a real component and an imaginary component. These components may be passed as inputs to a kernel function such as a harmonic or exponential function (e.g., a harmonic expansion), where the order of the kernel function may be dictated by information known about the transmission technology of the aggressor or victim signal. Alternatively, the entire aggressor signal may be passed to the kernel generator and the resulting kernel separated into a real component and an imaginary component. In either embodiment, the result of kernel function execution may be a two-element vector having an element representing the aggressor kernel real component and the aggressor kernel imaginary component.

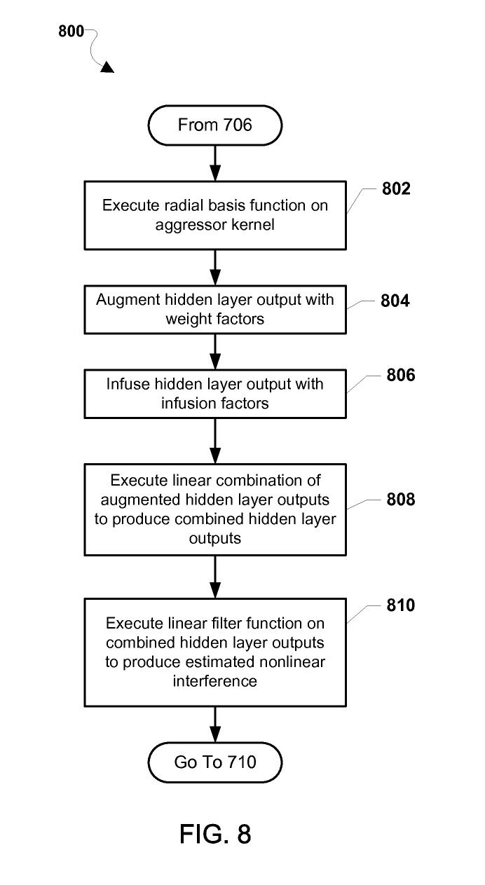

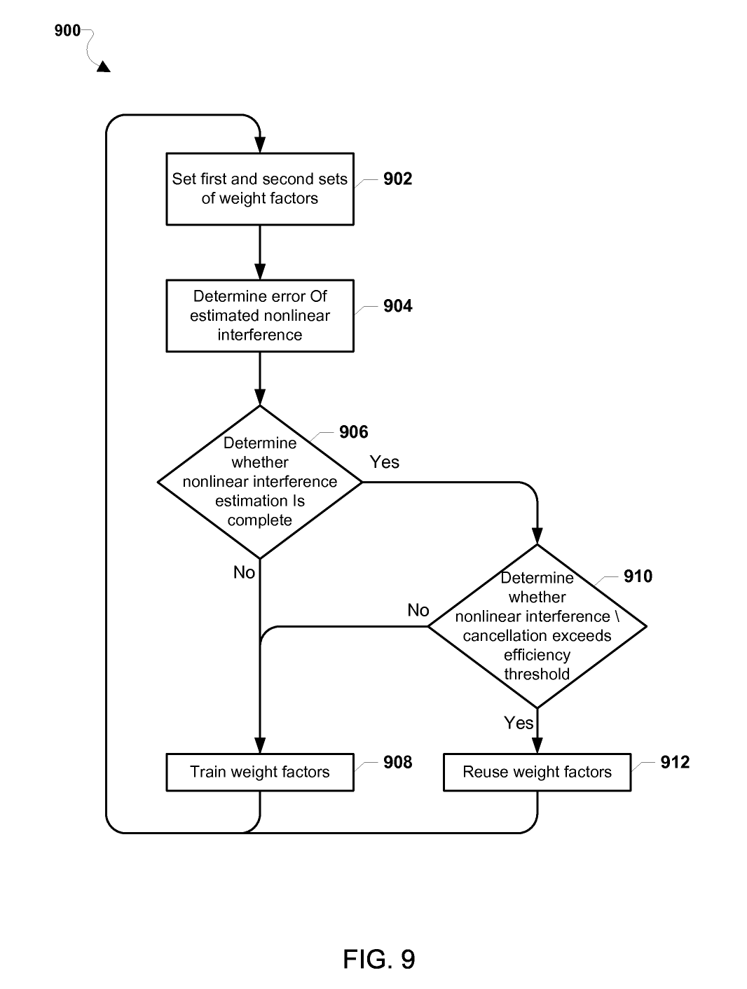

In block 708, the processor of the multi-technology communication device may estimate the nonlinear interference of the victim signal caused by the aggressor signal(s). This estimation of the nonlinear interference is discussed in further detail (e.g., with reference to FIGS. 8 and 9). In block 710, the multi-technology communication device may cancel an estimated nonlinear interference signal from the victim signal. Canceling or removing the estimated nonlinear interference from the victim signal may be implemented in a variety of known ways, such as filtration, transformation, extraction, reconstruction, and suppression. In block 712, the multi-technology communication device may decode the victim signal without presence of the interference by the aggressor signal(s). In block 714, the multi-technology communication device may advance to the next time interval “i” (e.g., move to the current time interval) and begin the process again with regard to aggressor and victim signals for the current time “i”.

FIG. 8 illustrates a method 800 for estimating nonlinear interference using a multi-model radial basis function neural network with Hammerstein structure (e.g., 400 in FIG. 4) in a multi-technology wireless communications device in accordance with various embodiments. With reference to FIGS. 1-8, the method 800 may be executed in a computing device (e.g., 110, 120, 200 in FIGS. 1 and 2) using software, general purpose or dedicated hardware, or a combination of software and hardware, such as the general purpose processor 206 (FIG. 2), baseband processor 216, or the like. In one example, the method may be performed by a processor of the multi-technology communication device. The method 800 may be included in method 700 in FIG. 7 as part of block 708. As described above, the victim signal and the aggressor signal or aggressor kernel may be used by the multi-technology communication device as input signals for the radial basis function neural network with Hammerstein structure. The victim signal and the aggressor signal or aggressor kernel may be received by the input layer of the multi-model radial basis function neural network. The aggressor signal and/or aggressor kernel may be divided into one or more real and imaginary components. The real and imaginary components of the aggressor signal and/or aggressor kernel may be used as hidden layer input signals and/or intermediate layer input and maybe manipulated in the estimation of the estimated nonlinear interference.

In block 802, the processor of the multi-technology communication device may execute a radial basis function on the aggressor kernels components at hidden layer to produce a hidden layer outputs. The radial basis function may include any known radial basis functions suitable for signal processing, including a Gaussian function. The results of the radial basis function execution may be hidden layer outputs. There may be 2K hidden layer outputs where “K” is the number of nodes, each of which produces both a hidden layer output (real) and a hidden layer output (imaginary). These hidden layer outputs may be passed to an intermediate layer for augmentation and combination.

In block 804, the processor may augment the hidden layer outputs with weight factors at an intermediate layer of the multi-model radial basis function neural network with Hammerstein structure. As described above, in various embodiments, the weight factors may be determined at random, be preprogrammed, and/or trained as described with reference to FIG. 9. In some embodiments, weight factors may be determined based on training that uses the taps of the linear filter function and associated weighting coefficients.

In block 806 the processor of the multi-technology communication device may, at an intermediate layer of the multi-model radial basis function neural network, infuse the hidden layer outputs with infusion factors. As described, in various embodiments, the infusion factors may be linear (e.g., real and imaginary aggressor signal components 502a, 502b) or may be the complex (e.g., real and imaginary aggressor kernel components 506, 508). In embodiments in which the input layer passes the aggressor kernel components to the hidden layer, the infusion factors may be the real and imaginary aggressor signal components 502a, 502b. In embodiments in which the input layer passes the aggressor signal components to the hidden layer, the infusion factors may be the real and imaginary aggressor kernel components 506, 508.

In block 808, the processor of the multi-technology communication device may execute a linear combination of the augmented and infused hidden layer outputs. In some embodiments, the augmentation and linear combination may be executed through mathematical and/or logical operations. The operations implementing the augmentation may result in a multiplication of a respective weight factor with a respective hidden layer output. The operations implementing the linear combination may result in the summation of the augmented and infused hidden layer input signals. In some embodiments, multiplication of weight factors and/or infusion factors with the hidden layer outputs may occur during the summation such that a weight factor and/or infusion factor is multiplied by a hidden layer output at subsequent iterations of the summation. The linear combination of the augmented and infused hidden layer outputs may be labeled as the combined hidden layer outputs. Like the aggressor kernel, the combined hidden layer output may be a two element vector having an element representing a real component and an element representing an imaginary component. These combined hidden layer outputs may be passed as input to an output layer.

In block 810, the processor may execute a linear filter function on the combined hidden layer outputs at an output layer of the multi-model radial basis function neural network with Hammerstein structure. The linear filter function may be an impulse response filter such as a finite impulse response filter. The linear filter function may sample, augment and linearly combine the combined hidden layer outputs. The linear filter function may have a delay line for each of the combined hidden layer output real and imaginary components, and may iteratively sample the components. Sampled output components are augmented with an element of a second set of weight factors and linearly combined. In some embodiments, the augmentation and linear combination may be executed through mathematical and/or logical operations. Augmentation may include multiplying the output layer weight factors with respective post-sampling, combined hidden layer output. The linear combination may result in the summation of the augmented, post-sampling combined hidden layer input signals. In some embodiments, multiplication of weight factors with the hidden layer outputs may occur during the summation such that a weight factor is multiplied by a post-sampling, combined, hidden layer output at subsequent iterations of the summation. The linear combination of the augmented, post-sampling, combined, hidden layer outputs may be real and imaginary components of an estimated nonlinear interference, and may have both real and imaginary components. These real and imaginary components may be combined to provide a total estimated nonlinear interference, which may be cancelled from a received signal as described at operation 710.

FIG. 9 illustrates a method 900 for training weight factors for use in a radial basis function neural network with Hammerstein structure (e.g., 400 in FIG. 4) in a multi-technology wireless communications device in accordance with various embodiments. With reference to FIGS. 1-9, the method 900 may be executed in a computing device (e.g., 110, 120, 200 in FIGS. 1 and 2) using software, general purpose or dedicated hardware, or a combination of software and hardware, such as the general purpose processor 206 (FIG. 2), baseband processor 216, or the like. In one example, the method may be performed by a processor of the multi-technology communication device. In block 902, the processor of the multi-technology communication device may select the weight factors for augmenting the hidden layer input signals and the second set of weight factors for use in the linear filter function. As described, in various embodiments, the weight factors may be determined at random, be preprogrammed, and/or trained. The weight factors may be selected from a range of values configured to reduce the error of the estimated nonlinear interference. A non-limiting example range includes values of about −0.5 to about 0.5. In some embodiments the weight factors may be trained using a series of mathematical operations in which the first weight factors are randomly selected and trained using a default set of the second weight factors; and the second set of weight factors is trained using the recently trained first set of weight factors and a second set of mathematical operations.

In block 904, the processor of the multi-technology communication device may determine an error present in the estimate of the nonlinear interference. Various known methods for determining the error of a function may be used to determine the error in block 904. In some embodiments, the error calculation may be for the mean square error of the estimated nonlinear interference compared with the nonlinear interference signal caused by the aggressor signal(s).

In determination block 906, the processor of the multi-technology communication device may determine whether the estimation of the nonlinear interference is complete. Estimation of the nonlinear interference may be considered to be complete at such time as the radial basis function neural network with Hammerstein structure has finished execution and an estimated nonlinear interference signal has been obtained (i.e., the real and imaginary estimated nonlinear interference have been combined). In response to determining that the estimation of the nonlinear interference is incomplete (i.e., determination block 906=“No”), the processor of the multi-technology communication device may train the weight factors in block 908. In various embodiments, the weight factors may be trained using a variety of optimization algorithms, for example least squares, gradient decent, the Gauss-Newton algorithm, and the Levenberg-Marquardt algorithm. Training of the weight factors may be regressively executed to further reduce the error of the estimated nonlinear interference. The multi-technology communication device may continue selecting weight factors for augmenting the hidden layer inputs signals in block 902 and may select any combination of reused, newly added, or additionally trained weight factors.

In response to determining that the estimation of the nonlinear interference is complete (i.e., determination block 906=“Yes”), the multi-technology communication device may determine whether the nonlinear interference cancellation exceeds an efficiency threshold in determination block 910. The determination of whether the nonlinear interference cancellation exceeds the efficiency threshold may be a measure of whether the nonlinear interference is cancelled sufficient to enable the multi-technology communication device to decode and use the victim signal. The efficiency threshold may be a precalculated or predetermined value based on historical observations of a level of accuracy present in an estimated nonlinear interference signal that is necessary to enable proper decoding of a victim signal. In some embodiments, the efficiency threshold may be based on the error value determination of the nonlinear interference in block 904, in which the error level may be compared to an acceptable error level. In some embodiments, the efficiency threshold may be based on a success rate for decoding and using the victim signal. In response to determining that the nonlinear interference cancellation does not exceed the efficiency threshold (i.e., determination block 910=“No”), the multi-technology communication device may continue to train the weight factors in block 908. Training the weight factors may reduce the amount of error in the estimated nonlinear interference so that the cancellation of the estimated nonlinear interference may result in greater success of decoding and using the victim signal.

In response to determining that the nonlinear interference cancellation does exceed the efficiency threshold (i.e., determination block 910=“Yes”), the multi-technology communication device may reuse the weight factors for subsequent estimation and cancellation of nonlinear interference in block 912. As described, the multi-technology communication device may not always train the weight factors when estimating the nonlinear interference. The nonlinear interference caused by the one or more aggressor signals may vary by different amounts under various conditions. In some embodiments, the variation in the nonlinear interference may be small enough that the previously trained weight factors may result in a sufficiently accurate estimated nonlinear interference that further training is unnecessary. Determining when to train the weight factors or reuse the weight factors may be based on one or more criteria, including time, measurements of the aggressor signal(s), victim signal quality, and nonlinear interference noise cancellation efficiency, for example including error of the estimated nonlinear interference and/or success of decoding and using the victim signal.

In some embodiments, the method 900 may be executed at various times before, during, or after the execution of the method 700 and the method 800. For example, the method 900 may be executed to calculate at least some of the weight factors before they are used to augment the hidden layer input signals in block 804. In some embodiments, certain blocks of the method 900 the method may not execute contiguously, but may instead execute interspersed with the blocks of the methods 700, 800.

In other words, the methods may manage interference such as signal interference (e.g., non-linear interference) that is present in a signal received in a multi-technology communication device. Managing or analyzing interference may include filtering a received aggressor signal using a radial basis function neural network with Hammerstein structure. The radial basis function neural network may include a number of layers (input layer, hidden layer, intermediate layer, output layer, etc.) in which different mathematical operations are executed, thereby extracting a numerical representation of estimated interference from the received aggressor signal.

The multi-technology communication device may receive an aggressor signal (i.e., a signal interfering with or impeding another received signal) at an input layer of the radial basis function neural network. The multi-technology communication device may generate a radial basis function (RBF) kernel, which may contain both real and imaginary elements or components (i.e., elements represented by real numbers and elements represented by imaginary numbers). The multi-technology communication device may execute a radial basis function on the RBF kernel at a hidden layer to produce hidden layer outputs. The hidden layer may include multiple nodes, each receiving one or more elements of the RBF kernel and executing the radial basis function on the kernel resulting in the hidden layer outputs. The multi-technology communication device may augment the hidden layer outputs with weight factors (weights, weighting components) at an intermediate layer of the radial basis function neural network to produce augmented or combined hidden layer outputs. Augmentation may include multiplying each result of the radial basis function execution by a corresponding weight element (i.e., a multiplier). The multi-technology communication device may also infuse (i.e., augment) the augmented hidden layer outputs with infusion factors, or a second set of weights, a bias, vector, or other set of values. Infusion may include multiplication or addition of the infusion factors (infusion components, infusion values) with elements of the augmented hidden layer outputs. The multi-technology communication device may linearly combine, sum, or add the infused hidden layer outputs at the intermediate layer to produce combined hidden layer outputs. The multi-technology communication device may execute a linear filter function, FIR filter, finite impulse response filter, or Hammerstein structure on the combined hidden layer outputs at an output layer of the radial basis function neural network with Hammerstein structure to obtain estimated nonlinear interference. A result of the filtering/extracting may be an estimated interference (estimated nonlinear interference, estimated interference signal), which may be subtracted from the received victim signal (i.e., the signal subject to interference by the aggressor signal) to produce a mathematical representation of the intended received signal.

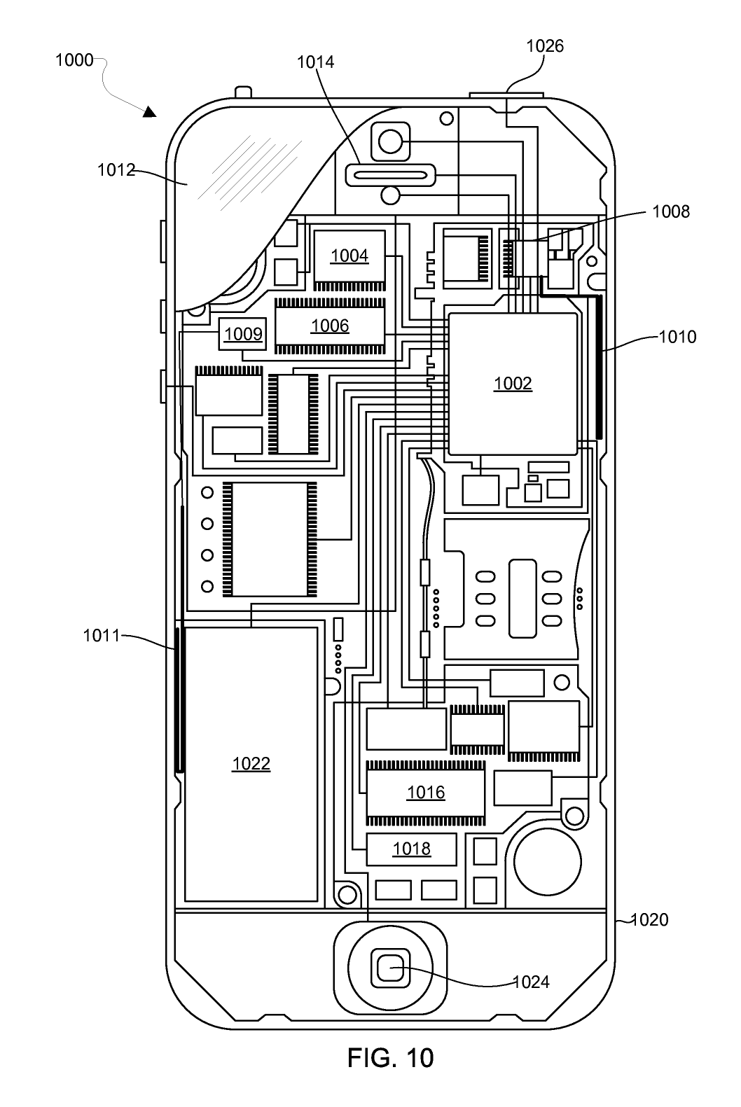

FIG. 10 illustrates an exemplary multi-technology communication device 1000 suitable for use with the various embodiments. The multi-technology communication device 1000 may be similar to the multi-technology device 110, 120, 200 (e.g., FIGS. 1 and 2). With reference to FIGS. 1-10, the multi-technology communication device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the multi-technology communication device 1000 need not have touch screen capability.

The multi-technology communication device 1000 may have two or more cellular network transceivers 1008, 1009 coupled to antennae 1010, 1011, for sending and receiving communications via a cellular communication network. The combination of the transceiver 1008 or 1009 and the associated antenna 1010 or 1011, and associated components, is referred to herein as a radio frequency (RF) chain. The cellular network transceivers 1008, 1009 may be coupled to the processor 1002, which is configured with processor-executable instructions to perform operations of the embodiment methods described above. The cellular network transceivers 1008, 1009 and antennae 1010, 1011 may be used with the above-mentioned circuitry to implement the various wireless transmission protocol stacks and interfaces. The multi-technology communication device 1000 may include one or more cellular network wireless modem chips 1016 coupled to the processor and the cellular network transceivers 1008, 1009 and configured to enable communication via cellular communication networks.

The multi-technology communication device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as USB, FireWire, Thunderbolt, or PCIe. The peripheral device connection interface 1018 may also be coupled to a similarly configured peripheral device connection port (not shown).

The multi-technology communication device 1000 may also include speakers 1014 for providing audio outputs. The multi-technology communication device 1000 may also include a housing 1020, constructed of a plastic, metal, or a combination of materials, for containing all or some of the components discussed herein. The multi-technology communication device 1000 may include a power source 1022 coupled to the processor 1002, such as a disposable or rechargeable battery. The rechargeable battery may also be coupled to the peripheral device connection port to receive a charging current from a source external to the multi-technology communication device 1000. The multi-technology communication device 1000 may also include a physical button 1024 for receiving user inputs. The multi-technology communication device 1000 may also include a power button 1026 for turning the multi-technology communication device 1000 on and off.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the various embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method for managing signal interference in a multi-technology communication device, comprising:
receiving an aggressor signal at an input layer of a radial basis function neural network (RBF neural network);
generating an aggressor kernel from the aggressor signal;
executing a radial basis function on the aggressor kernel at a hidden layer of the RBF neural network to produce hidden layer outputs;
augmenting the hidden layer outputs with weight factors at an intermediate layer of the RBF neural network to produce augmented hidden layer outputs;
infusing the augmented hidden layer outputs with infusion factors at the intermediate layer of the RBF neural network to produce infused hidden layer outputs;
linearly combining the infused hidden layer outputs at the intermediate layer to produce combined hidden layer outputs; and
executing a linear filter function on the combined hidden layer outputs at an output layer of the RBF neural network to obtain estimated nonlinear interference.

2. The method of claim 1, further comprising:
determining an error of the estimated nonlinear interference;
determining whether the error of the estimated nonlinear interference exceeds an efficiency threshold; and
canceling the estimated nonlinear interference from a victim signal.

3. The method of claim 2, further comprising training the weight factors to reduce the error of the estimated nonlinear interference.

4. The method of claim 3, wherein:
training the weight factors to reduce the error of the estimated nonlinear interference comprises training weight factors in response to determining that the error of the estimated nonlinear interference exceeds the efficiency threshold; and
canceling, the estimated nonlinear interference from the victim signal comprises canceling the estimated nonlinear interference from the victim signal in response to determining that the error of the estimated nonlinear interference does not exceed the efficiency threshold.

5. The method of claim 3, further comprising training the weight factors using a least squares method.

6. The method of claim 1, further comprising training centroids of each node of the radial basis function prior to execution of the linear filter function.

7. The method of claim 1, wherein the linear filter function is a finite impulse response filter.

8. The method of claim 1, wherein the linear filter function has a Hammerstein structure.

9. The method of claim 1, wherein the radial basis function is Gaussian.

10. The method of claim 1, wherein the received aggressor signal represents the aggressor signal received by an antenna of the multi-technology communication device at a specific instance in time.

11. The method of claim 1, wherein generating the aggressor kernel comprises
separating the aggressor signal into a real aggressor component and an imaginary aggressor component;
executing a kernel function on the real aggressor component and the imaginary aggressor component to obtain the aggressor kernel having a real kernel component and an imaginary kernel component.

12. The method of claim 1, wherein the aggressor kernel is a set of non-linear inputs derived from the received aggressor signal.

13. The method of claim 1, further comprising canceling the estimated nonlinear interference from a victim signal received by an antenna.

14. The method of claim 13, further comprising decoding the victim signal after canceling the estimated nonlinear interference from the victim signal.

15. The method of claim 1, further comprising training a second set of weight factors using the weight factors of the intermediate layer, wherein the second set of weight factors are associated with the linear filter function.

16. The method of claim 1, wherein augmenting the hidden layer outputs with the weight factors, infusing with the infusion factors, and linearly combining are performed in a single function.

17. The method of claim 1, wherein the infusion factors are the aggressor kernel.

18. The method of claim 1, wherein the infusion factors are the aggressor signal.

19. The method of claim 18, wherein the infusion factors comprise a real aggressor component of the aggressor signal and an imaginary aggressor component of the aggressor signal.

20. A multi-technology communication device, comprising:
an antenna;
a processor communicatively connected to the antenna and configured with processor-executable instructions to perform operations comprising:
receive an aggressor signal at an input layer of a radial basis function neural network (RBF neural network);
generate an aggressor kernel from the aggressor signal;
execute a radial basis function on the aggressor kernel at a hidden layer of the RBF neural network to produce hidden layer outputs;
augment the hidden layer outputs with weight factors at an intermediate layer of the RBF neural network to produce augmented hidden layer outputs;
infuse the augmented hidden layer outputs with infusion factors at the intermediate layer of the RBF neural network to produce infused hidden layer outputs;
linearly combining the infused hidden layer outputs at the intermediate layer to produce combined hidden layer outputs; and
execute a linear filter function on the combined hidden layer outputs at an output layer of the RBF neural network to obtain estimated nonlinear interference.

21. The multi-technology communication device of claim 20, wherein the processor is configured with processor-executable instructions to perform operations such that generating the aggressor kernel comprises:
separating the aggressor signal into a real aggressor component and an imaginary aggressor component; and
executing a kernel function on the real aggressor component and the imaginary aggressor component to obtain the aggressor kernel having a real kernel component and an imaginary kernel component.

22. The multi-technology communication device of claim 20, wherein the processor is configured with processor-executable instructions to perform operations further comprising canceling the estimated nonlinear interference from a victim signal received by the antenna.

23. The multi-technology communication device of claim 22, wherein the processor is configured with processor-executable instructions to perform operations further comprising decoding the victim signal after canceling the estimated nonlinear interference from the victim signal.

24. The multi-technology communication device of claim 20, wherein the processor is configured with processor-executable instructions to perform operations further comprising training a second set of weight factors using the weight factors of the intermediate layer, wherein the second set of weight factors are associated with the linear filter function.

25. The multi-technology communication device of claim 20, wherein the processor is further configured with processor-executable instructions to perform the operations of augmenting the hidden layer outputs with the weight factors, infusing with the infusion factors, and linearly combining in a single function.

26. The multi-technology communication device of claim 20, wherein the processor is configured with processor-executable instructions to perform operations such that the infusion factors are the aggressor kernel.

27. The multi-technology communication device of claim 20, wherein the processor is configured with processor-executable instructions to perform operations such that the infusion factors are the aggressor signal.

28. The multi-technology communication device of claim 20, wherein the processor is configured with processor-executable instructions to perform operations such that the infusion factors comprise a real aggressor component of the aggressor signal and an imaginary aggressor component of the aggressor signal.

29. A multi-technology communication device, comprising:
means receiving an aggressor signal at an input layer of a radial basis function neural network (RBF neural network);
means for generating an aggressor kernel from the aggressor signal;
means for executing a radial basis function on the aggressor kernel at a hidden layer of the RBF neural network to produce hidden layer outputs;
means for augmenting the hidden layer outputs with weight factors at an intermediate layer of the RBF neural network to produce augmented hidden layer outputs;
means for infusing the augmented hidden layer outputs with infusion factors at the intermediate layer of the RBF neural network to produce infused hidden layer outputs
means for linearly combining the infused hidden layer outputs at the intermediate layer to produce combined hidden layer outputs; and
means for executing a linear filter function on the combined hidden layer outputs at an output layer of the RBF neural network to obtain estimated nonlinear interference.

30. A non-transitory processor-readable medium having stored thereon processor-executable software instructions to cause a processor of a multi-technology communication device to perform operations comprising:
receiving an aggressor signal at an input layer of a radial basis function neural network (RBF neural network);
generating an aggressor kernel from the aggressor signal;
executing a radial basis function on the aggressor kernel at a hidden layer of the RBF neural network to produce hidden layer outputs;
augmenting the hidden layer outputs with weight factors at an intermediate layer of the RBF neural network to produce augmented hidden layer outputs;
infusing the augmented hidden layer outputs with infusion factors at the intermediate layer of the RBF neural network to produce infused hidden layer outputs;
linearly combining the infused hidden layer outputs at the intermediate layer to produce combined hidden layer outputs; and
executing a linear filter function on the combined hidden layer outputs at an output layer of the RBF neural network to obtain estimated nonlinear interference.
